(19) United States
(12) Patent Application Publication
(10) Pub. No.: US 2009/0160306 A1
(43) Pub. Date: Jun. 25, 2009

(54) Thermal electron emission source having carbon nanotubes and method for making the same

(75) Inventors: Lin Xiao, Bei-Jing (CN); Peng Liu, Bei-Jing (CN); Liang Liu, Bei-Jing (CN); Kai-Li Jiang, Bei-Jing (CN); Yang Wei, Bei-Jing (CN); Li Qian, Bei-Jing (CN); Shou-Shan Fan, Bei-Jing (CN)

Correspondence Address: PCE INDUSTRY, INC.;ATT. Steven Reiss, 458 E. LAMBERT ROAD, FULLERTON, CA, 92835, US

(73) Assignees: Tsinghua University; Hon Hai Precision Industry Co., LTD.

(21) Appl. No.: 12/080,604

(22) Filed: Apr. 4, 2008

(30) Foreign Application Priority Data
Dec. 19, 2007 (CN) 200710125263.5

(51) Int. Cl. H01J 1/02; H01J 9/02

(52) U.S. Cl. 313/310; 445/51

(57) ABSTRACT

A thermal electron emission source includes a first electrode, a second electrode insulated from the first electrode, a carbon nanotube string electrically connected to and in contact with the first electrode and the second electrode, and a number of electron emission particles. The carbon nanotube string is composed of a number of closely packed carbon nanotube bundles, and each of the carbon nanotube bundles includes a number of carbon nanotubes. The electron emission particles are uniformly dispersed in the carbon nanotube string and are coated on the surfaces of the carbon nanotubes. A method for making the thermal electron emission source is also provided.

### RELATED APPLICATIONS

This application is related to commonly-assigned, co-pending application: U.S. patent application Ser. No. 12/006,305, entitled “METHOD FOR MANUFACTURING FIELD EMISSION ELECTRON SOURCE HAVING CARBON NANOTUBES”, filed Dec. 29, 2007. The disclosure of the above-identified application is incorporated herein by reference.

### BACKGROUND

1. Field of the Invention

The present invention relates to thermal electron emission sources and, more particularly, to a thermal electron emission source including carbon nanotubes and a method for making the same.

2. Discussion of Related Art

A thermal electron emission source is a device widely applied in gas lasers, arc-welding, plasma-cutting, electron microscopy, x-ray generators, and the like. The conventional thermal electron emission source is constructed in that a layer of electron emissive alkaline earth metal oxide, such as BaO, SrO, CaO, or a mixture thereof, is formed on a base made of an alloy including at least one of Ni, Mg, W, Al and the like. When heated at a temperature of about 800° C., the thermal electron emission source emits electrons. In the process, an interface layer of, for example, Ba₃O₆ between the base and the alkaline earth metal oxide layer is formed. Further, after the temperature of the thermal electron emission source returns to the room temperature, a mechanical property (e.g., strength, durability) thereof is reduced because of a change in the crystal structure of the base. Therefore, the thermal electron emission source is less stable. Further, the alkaline earth metal oxide layer is only formed on the surface of the base, and thus a quantity of electron emissive alkaline earth metal oxide is limited. Consequently, the electron-emission lifespan thereof tends to be low.

What is needed, therefore, is a thermal electron emission source, which has stable and high efficiency electron emission, as wells as a high mechanical durability, and a method for making the thermal electron emission source.

### SUMMARY OF THE INVENTION

A thermal electron emission source includes a first electrode, a second electrode insulated from the first electrode, a carbon nanotube string electrically connected to and in contact with the first electrode and the second electrode, and a number of electron emission particles. The carbon nanotube string is composed of a number of closely packed carbon nanotube bundles, and each of the carbon nanotube bundles includes a number of the carbon nanotubes. The electron emission particles are uniformly dispersed in the carbon nanotube string and are coated on the surfaces of the carbon nanotubes.

A method for making the thermal electron emission source includes the following steps: providing a carbon nanotube array; drawing a plurality of carbon nanotube bundles from the carbon nanotube array to form a carbon nanotube yarn; soaking the carbon nanotube yarn in a alkaline earth metal salt solution; drying the carbon nanotube yarn to form a carbon nanotube string; activating the carbon nanotube string; and attaching the carbon nanotube string to the first electrode and second electrode, and finally achieving a thermal electron emission source.

Compared with the conventional thermal electron emission source, the present thermal electron emission source has the following advantages. Firstly, the carbon nanotube is stable at high temperature, and thus the thermal electron emission source has stable electron emission characteristics. Secondly, the electron emission particles are uniformly dispersed into the carbon nanotube string, providing more electron emission particles to emit more thermal electrons. Accordingly, the electron-emission efficiency thereof is improved. Thirdly, the carbon nanotube matrix of the present thermal emission source is mechanically durable, even at relatively high temperatures. Thus, the present thermal emission source can be expected to display longer lifespan and better mechanical behavior, when in use, than previously available thermal emission sources.

Other advantages and novel features of the present thermal electron emission source and a method for making the same will become more apparent from the following detailed description of preferred embodiments when taken in conjunction with the accompanying drawings.

### BRIEF DESCRIPTION OF THE DRAWINGS

Many aspects of the present thermal electron emission source and the present method for making the same can be better understood with reference to the following drawings. The components in the drawings are not necessarily to scale, the emphasis instead being placed upon clearly illustrating the present thermal electron emission source.

FIG. 1 is a schematic, perspective view of a thermal electron emission source, according to a first embodiment.

FIG. 2 is a Scanning Electron Microscope (SEM) photo, showing a CNT string of the thermal electron emission source, according to the first embodiment.

FIG. 3 is a flow process chart, showing a method for making a thermal electron emission source, according to the first embodiment.

### DETAILED DESCRIPTION OF PREFERRED EMBODIMENTS

The present thermal electron emission source is further described below with reference to the drawings.

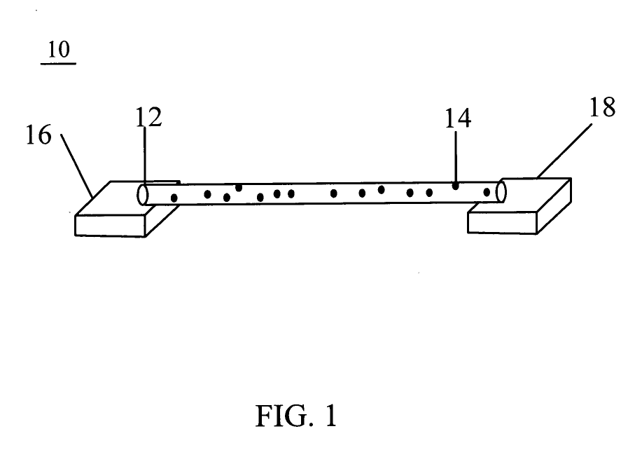

Referring to FIG. 1, a thermal electron emission source 10 includes a carbon nanotube (CNT) string 12 functioning as a matrix, a number of electron emission particles 14 uniformly dispersed into the CNT string 12, a first electrode 16, and a second electrode 18. Two opposite ends of the CNT string 12 are respectively electrically connected to and in contact with the first electrode 16 and the second electrode 18 by a conductive paste/adhesive, such as a silver paste. The first and second electrodes 16 and 18 are separated and insulated from each other and made of a conductive material, such as a metal or alloy.

The electron emission particles 14 are made of at least one low work function material selected from the group consisting of alkaline earth metal oxides, alkaline earth metal borides, and a mixture thereof. The alkaline earth metal oxides are beneficially materials selected from the group consisting of barium oxide, calcium oxide, and strontium oxide. The alkaline earth metal borides are advantageously materials selected from the group consisting of thorium boride and yttrium boride. A diameter of the electron emission particle is, rather usefully, in an approximate range from 1 nanometer (nm) to 1 millimeter (mm).

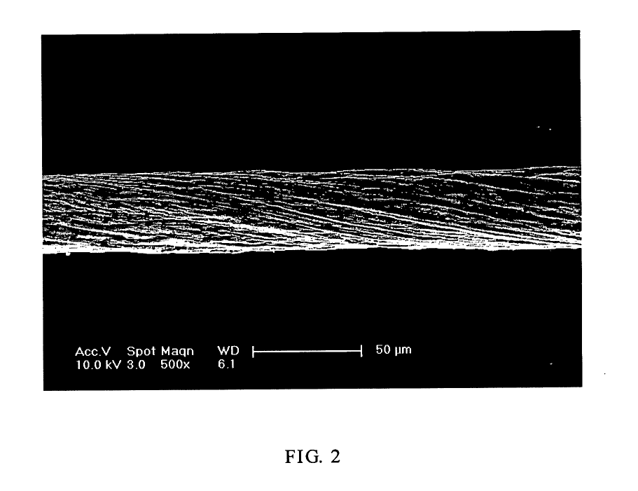

Referring to FIG. 2, the CNT string 12 is composed of a number of closely packed CNT bundles, and each of the CNT bundles includes a number of CNTs. Such CNTs are substantially parallel to each other and are joined by van der Waals attractive force. The electron emission particles 14 are attached to the surfaces of the CNTs in the CNT string 12. The CNT string 12 forms a stranded structure, with the CNT bundles being stranded by a spinning process. A diameter of the CNT string 12 is in an approximate range of about 1 to 100 microns (μm), and a length thereof is in an approximate range of about 0.1-10 centimeters (cm).

In operation, a voltage is supplied between the first electrode 16 and the second electrode 18, and thus a current flows through the CNT string 12. The CNT string 12 is heated up rather efficiently due to Joule/resistance heating, and thus the temperature of the electron emission particles 14 is able to rise rather quickly upon the subjecting of the CNT string 12 to a current flow. When the temperature over about 800° C., the electron emission particles 14 begin to emit electrons.

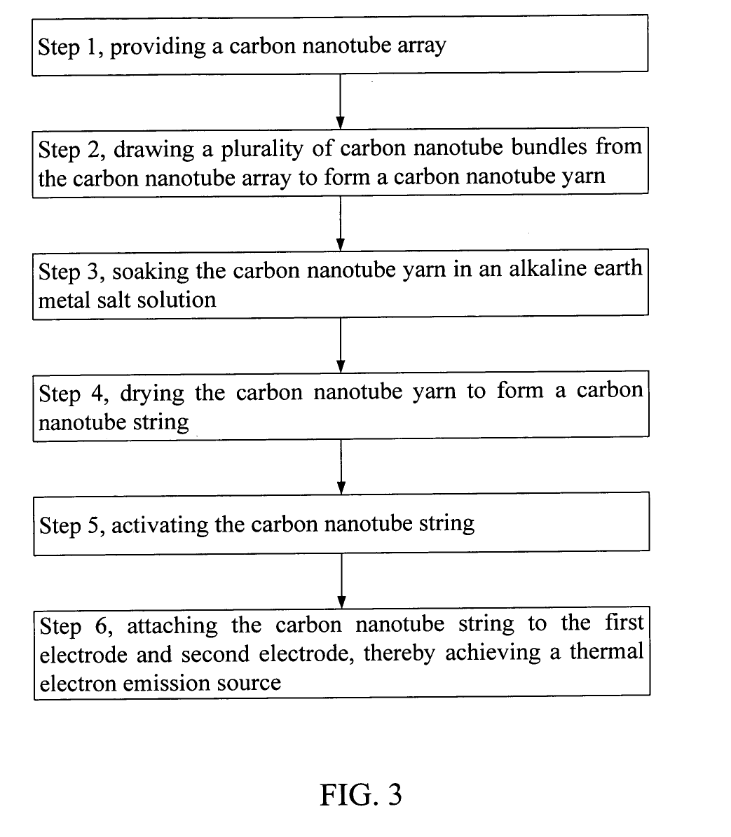

Referring to FIG. 3, a method for making the thermal electron emission source 10 is illustrated in the form of the following steps:

Step 1, providing a CNT array;
Step 2, drawing a number of CNT bundles from the CNT array to form a CNT yarn;
Step 3, soaking the CNT yarn in an alkaline earth metal salt solution;
Step 4, drying the CNT yarn to form a CNT string;
Step 5, activating the CNT string; and
Step 6, attaching the CNT string to the first electrode and second electrode, thereby achieving a thermal electron emission source.

In step 1, the CNT array is a super-aligned CNT array, which is advantageously grown using a chemical vapor deposition method. The method is described in U.S. Pat. No. 7,045,108, which is incorporated herein for reference. Firstly, a substrate is provided, and the substrate can, e.g., be p type silicon or n type silicon substrate. Secondly, a catalyst layer is deposited on the substrate. The catalyst layer is made of a material selected from a group consisting of iron (Fe), cobalt (Co), nickel (Ni), and their alloys. Thirdly, the substrate with the catalyst layer is annealed at a temperature in an approximate range from 300 to 400 degrees centigrade under a protecting gas for a while. Fourthly, the substrate with the catalyst layer is heated to approximately 500 to 700 degrees centigrade and a mixed gas including a carbon containing gas and a protecting gas is introduced for about 5 to 30 minutes to grow a super-aligned CNTs array. The carbon containing gas can be a hydrocarbon gas, such as acetylene or ethane. The protecting gas can be an inert gas. The grown CNTs are aligned parallel in columns and held together by van der Waals force interactions. The CNTs array has a high density and each one of the CNTs has an essentially uniform diameter. It is to be understood, however, that any CNT array production process that is able to yield a super-aligned array could be used and be within the scope of the present method.

In step 2, a CNT yarn may be obtained by drawing a number of the CNT bundles from the super-aligned CNTs array. Firstly, the CNT bundles include at least two CNTs are selected. Secondly, the CNT bundles are drawn out using, e.g., forceps or adhesive tape, to form a CNT yarn along the drawn direction. The CNT bundles are connected together by van der Waals force interactions to form a continuous CNT yarn. Each CNT bundle includes a number of substantially parallel CNTs.

In step 3, The CNT yarn is soaked in the alkaline earth metal salt solution, and the alkaline earth metal salt solution intercalates into the CNT yarn. The alkaline earth metal salt solution includes an alkaline earth metal salt and a solvent. In the present embodiment, the alkaline earth metal salt is a mixture of barium nitrate, strontium nitrate, wherein calcium nitrate with a molar ratio of 1:1:0.05, the solvent is a mixture of deionized water and ethanol with a volume ratio of 1:1, and the concentration of barium ion is about 0.1-1 mol/L.

In step 4, the CNT yarn is dried in air and at a temperature of about 100-400° C. The alkaline earth metal salt particles are deposited on the surface of the CNTs of the CNT yarn. Further, since the untreated CNT yarn is composed of a number of the CNTs, the untreated CNT yarn has a high surface area to volume ratio and thus may easily become stuck to other objects. After volatilizing the solvent, the CNT yarn is shrunk into a CNT string 12, due to factors such as surface tension. The surface area to volume ratio and diameter of the treated CNT string 12 is, as a result, reduced. Accordingly, the stickiness of the CNT yarn is lowered or eliminated, and strength and toughness of the CNT string 12 is improved.

Moreover, the CNT string 12 is stranded by a spinning process, and then the mechanical properties (e.g., strength and toughness) thereof can be further improved.

In step 5, the CNT string 12 is placed into a sealed furnace having a vacuum or inert gas atmosphere. In the present embodiment, in a vacuum of about 10⁻²-10⁻⁶ Pascals (Pa), the CNT string 12 is supplied with a voltage until the temperature of the CNT string reaches about 800-1400° C. Holding the temperature for about 1-60 minutes, the alkaline earth metal salt is decomposed to the alkaline earth metal oxide. After being cooled to the room temperature, the thermally emissive CNT string 12 is formed, with the alkaline earth metal oxide particles uniformly dispersed on the surface of the CNTs thereof. The alkaline earth metal oxide particles thereon are the electron emission particles 14.

In step 6, the CNT string 12 is respectively attached to the first and second electrodes 16, 18 by a conductive paste/adhesive, such as a silver paste. That is, the one end of the CNT string 12 is attached to the first electrode 16, and the opposite end of the CNT string 12 is attached to the second electrode 18.

Finally, it is to be understood that the embodiments mentioned above are intended to illustrate rather than limit the invention. Variations may be made to the embodiments without departing from the spirit of the invention as claimed. The above-described embodiments illustrate the scope of the invention but do not restrict the scope of the invention.

What is claimed is:

1. A thermal electron emission source comprising:
a first electrode;
a second electrode spaced and insulated from the first electrode;
a carbon nanotube string electrically connected to and in contact with the first electrode and the second electrode, the carbon nanotube string being composed of a plurality of closely packed carbon nanotube bundles, each of the carbon nanotube bundles comprising a plurality of carbon nanotubes; and
a plurality of electron emission particles uniformly dispersed in the carbon nanotube string and coated on the surfaces of the carbon nanotubes.

2. The thermal electron emission source as claimed in claim 1, wherein the carbon nanotubes are substantially parallel to each other and are joined by van der Waals attractive forces.

3. The thermal electron emission source as claimed in claim 1, wherein the electron emission particles are made of at least one low work function material selected from the group consisting of an alkaline earth metal oxide, an alkaline earth metal boride, and mixtures thereof.

4. The thermal electron emission source as claimed in claim 3, wherein the alkaline earth metal oxide is a material selected from the group consisting of barium oxide, calcium oxide, and strontium oxide.

5. The thermal electron emission source as claimed in claim 3, wherein the alkaline earth metal boride is a material selected from the group consisting of thorium boride and yttrium boride.

6. The thermal electron emission source as claimed in claim 1, wherein a diameter of each electron emission particle is in an approximate range from 1 nanometer to 1 millimeter.

7. The thermal electron emission source as claimed in claim 1, wherein two opposite ends of the carbon nanotube string are respectively attached to the first electrode and second electrode by a conductive paste.

8. The thermal electron emission source as claimed in claim 1, wherein the carbon nanotube string has a stranded structure.

9. The thermal electron emission source as claimed in claim 1, wherein a diameter of the carbon nanotube string is in an approximate range of about 1-100 microns, has a length of the carbon nanotube string is in an approximate range of about 0.1-10 centimeters.

10. A method for making the thermal electron emission source comprising:
providing a carbon nanotube array;
drawing a plurality of carbon nanotube bundles from the carbon nanotube array to form a carbon nanotube yarn;
soaking the carbon nanotube yarn in an alkaline earth metal salt solution;
drying the carbon nanotube yarn to form a carbon nanotube string;
activating the carbon nanotube string; and
attaching the carbon nanotube string to a first electrode and a second electrode, thereby achieving a thermal electron emission source.

11. The method for making the thermal electron emission source as claimed in claim 10, wherein the carbon nanotube array is a super-aligned CNT array.

12. The method for making the thermal electron emission source as claimed in claim 10, wherein the alkaline earth metal salt solution is comprised of an alkaline earth metal salt and a solvent.

13. The method for making the thermal electron emission source as claimed in claim 12, wherein the alkaline earth metal salt is a mixture of barium nitrate, strontium nitrate, and calcium nitrate with a molar ratio of 1:1:0.05.

14. The method for making the thermal electron emission source as claimed in claim 12, wherein the solvent is a mixture of deionized water and ethanol with a volume ratio of 1:1.

15. The method for making the thermal electron emission source as claimed in claim 10, wherein the carbon nanotube yarn is dried in air at a temperature of about 100-400° C.

16. The method for making the thermal electron emission source as claimed in claim 10, further comprising a spinning process to strand the carbon nanotube string.

17. The method for making the thermal electron emission source as claimed in claim 10, wherein the carbon nanotube string is activated in a vacuum or inert gas atmosphere and at a temperature of about 800-1400° C. for about 1-60 minutes.
